(19) United States
(12) Patent Application Publication
(10) Pub. No.: US 2024/0410157 A1
(43) Pub. Date: Dec. 12, 2024

(54) CONNECTION MEANS FOR CONNECTING WOODEN PARTS

(71) Applicant: Rotho Blaas SRL, Cortaccia (Bolzano) (IT)

(72) Inventor: Roland MADEREBNER, Innsbruck (AT)

(73) Assignee: Rotho Blaas SRL, Cortaccia (Bolzano) (IT)

(21) Appl. No.: 18/697,811

(22) PCT Filed: Sep. 22, 2022
(86) PCT No.: PCT/EP2022/076348

§ 371 Date: Apr. 2, 2024

(30) Foreign Application Priority Data
Oct. 4, 2021 (IT) 102021000025349

(51) Int. Cl. E04B 1/26; F16B 2/14; F16B 5/00

(52) U.S. Cl. CPC E04B 1/2604; F16B 2/14; F16B 5/0088; E04B 2001/2628; E04B 2001/2648; E04B 2001/2652; E04B 2001/2672

(57) ABSTRACT

Connection means for connecting a wood component which has a recess to an additional component, comprising at least one first flat element and at least one second flat element and at least one clamping element. The at least one first and second flat elements lie opposite each other and are mutually spaced when the connection means, including the flat elements and the clamping element, is inserted into the recess of the wood component, wherein the distance when clamping the clamping element can be modified. The at least one first and second flat element have a respective first and second surface, and the second surfaces of the first and second flat element face each other. The first surfaces of the first and second flat element have protrusions, and the at least one clamping element can be clamped in a form-fitting manner between the at least one first and second flat element.

### BACKGROUND OF THE INVENTION AND PRIOR ART

The present invention relates to a connecting means for connecting a wooden element having a recess to a further component comprising at least a first and at least a second panel element and at least one tensioning element. The invention also relates to a system consisting of a connecting means according to the invention and two wooden elements or a wooden element and a component, as well as a method for connecting a wooden element to a connecting means according to the invention.

In wooden construction, various connection systems are known for connecting wooden elements. The connecting means are usually pin-shaped, which results in a greatly reduced load capacity and rigidity.

Rigid panel joints can be made, for example, with the help of reaction resin or glued-in steel sheets. The reaction resin is filled into previously made recesses in the wooden elements in the area of the panel joint and then cured. The steel sheets can be inserted into previously made slots on the wooden elements, which are then filled with glue. The curing of the reaction resin takes a relatively long time and the use of reaction resin as a connecting means is therefore not suitable on construction sites, where work is usually carried out under great time pressure. The glued steel sheets cannot be used on construction sites where there is a lot of dust, as dust gets into the slots on the wooden elements and the adhesive therefore loses its adhesion. In addition, the use of reactive resins requires controlled conditions temperature and humidity, making them particularly unsuitable for use on construction sites

### BRIEF DESCRIPTION OF THE INVENTION

The object of the present invention is therefore to provide a connecting means for connecting wooden elements, which maintains the bending rigidity, can be attached very quickly and easily, even in a construction site environment, and without loss of rigidity and load-bearing capacity.

This object is achieved by a connecting means for connecting a wooden element having a recess to a further component,
comprising at least a first and at least a second panel element and,
at least one tensioning element,
   wherein the at least one first and second panel element lie opposite of each other, having a distance when inserting the connecting means together with panel elements and tensioning elements into the recess of the wooden elements, wherein the distance when tensioning the tensioning element is variable, the at least one first and second panel element each having a first and second surface, the second surfaces of the first and second panel elements facing each other, the first surfaces of the first and second panel elements having projections, wherein the at least one tensioning element can be positively clamped between the at least one first and second panel element.

The projections advantageously have a point, i.e. the projections can be pointy, which makes it easier for the projections to penetrate into the wooden element.

The distance between the plates can be between 4 mm to 80 mm, whereby the distance can be considered as the average of the distance between the plates and/or the internal net distance between the plates in the expansion direction (pressing direction).

The panel elements of the connecting means according to the invention can therefore be attached very easily to recesses in wooden elements. With the help of the panel elements including the tensioning element, a wooden element can be connected to a component in such a way that both transverse and longitudinal forces are transmitted. The connecting means therefore does not require any adhesive or reactive resins and still has very high flexural rigidity and high ductility.

An essential feature of the connecting means according to the invention are the projections on the first surface of the first and second panel elements. Because the first surfaces of the panel elements rest on the wooden elements, the projections can be pressed into the wood. The first surface of the first and second panel elements can, for example, have a serrated, toothed or grooved surface. A first surface resting on a wooden element thus has a high level of friction.

In addition, the projections of the first surfaces are pressed into the wood using the tensioning element. If the projections are pointed, they make it easier to press them in. As a result, acting forces are distributed along the entire panel element. The tensioning element also causes a changed distance between the first and second panel elements, since by tensioning the tensioning element, the projections are pressed ever deeper into the wooden element and the panel elements thus move apart.

The tensioning element thus spreads the panel elements and allows them to penetrate into the wood.

In one embodiment variant, the projections are distributed over the entire first surfaces of the panel elements, the shape of the projections being selected from the group of serrations, tines, teeth, grooves, notches, grooves, hooks or granules. The granules may also be glued to surfaces. These projections can be used to create a connection to the wooden element by mechanically engaging the projections in the wood. Such a connection has a performance that is comparable to the rigidity of an adhesive bond. In addition, the panel elements with the projections can be dismantled and thereby forming a non-invasive system.

The panel elements may also be nail plates, claw plates or the like.

When the tensioning element is inserted, the projections move deeper and deeper into the wood of the wooden elements, where they ultimately lock into place. Typically, panel elements with projections such as nail plates are attached to the exterior of wood using external hydraulic presses to provide the pressure necessary to incorporate the projections into the wood. According to the invention, the hydraulic presses are replaced by the tensioning element, which presses the projections of the panel elements into the wooden elements. After the projections have snapped into place in the wood, forces acting on them are absorbed by the projections and distributed over the entire surface of the panel elements. By pressing, a positive and frictional connection is created.

The density of the projections on the first surface of the panel elements can vary. A high density allows for high resistance and rigidity of the connecting means, but requires greater pressure until the projections are pressed into the wood.

Furthermore, the panel elements can be plates. The panels may have a thickness of 3 to 40 mm. This ensures that the wooden elements are coupled with high load-bearing capacity and rigidity.

In addition, the panel elements can be made of steel, stainless steel, aluminium or plastic.

In a further embodiment variant, the first and second panel elements can be convexly curved and form a pin-shaped connecting means with the tensioning element arranged between them. Such a connecting means can, for example, replace a cast-in threaded rod or the like. The connecting means does not have to be cast in and can therefore be adjusted or replaced more easily. Due to the projections on the panel elements and the tensioning element, the pin-shaped connecting means still offers the same level of performance as a cast-in connecting means.

In one embodiment variant, the at least one tensioning element is a clamping wedge.

Preferably, the at least one clamping wedge comprises a pin-shaped connecting means, preferably a fitting bolt, a threaded rod or a spindle, and at least one wedge that engages, wherein the at least one wedge has a bore, e.g. comprises a round or elongated bore with which the pin-shaped connecting means engages.

The clamping wedge can thus be inserted between the panel elements, with the wedge being able to be displaced along the pin-shaped connecting means. By resting the wedge on the second surfaces of the first and second panel elements, the distance between the panel elements can be changed using the clamping wedge.

In addition, the at least one clamping wedge can comprise a first and second wedge, the wedges having the same tapered basic shape and engaging with the pin-shaped connecting means in such a way that the tapered ends of the wedges point towards or away from one another, wherein the wedges rest with at least one wedge surface on the second surface of the first or second panel element. This symmetrical, opposing wedge effect of the clamping wedge designed in this way also enables symmetrical distribution of forces and therefore the most efficient tensioning element possible. The clamping wedge can be arranged between the panel elements and the wedges can be pressed in.

The wedges may, for example, be pressed between the panel elements using a threaded spindle. For this purpose, the threaded spindle engages with the hole in the wedges, which in this embodiment variant is a threaded hole. The threaded spindle has two opposing thread sections, each of which has a wedge screwed onto it. The two oppositely directed wedges can therefore be adjusted in opposite directions along the threaded spindle. By turning the threaded spindle, the distance between the panel elements can be varied very easily and the wedges can be wedged between the panel elements. At the same time, the projections on the first surfaces of the panel elements are also pressed into the wooden element.

In a further embodiment variant, the wedges are inserted and wedged between the panel elements using a fitting bolt. For this purpose, the fitting bolt is pressed or glued into the holes in the wedges.

In addition, the pin-shaped connecting means can also be a simple threaded rod, with the first wedge being displaceable along the threaded rod and the second wedge being screwable onto the threaded rod. The clamping wedge designed in this way can therefore be inserted between the first and second panel elements by first screwing the second wedge onto the threaded rod, which is then pushed between the panel elements with the still free end in front until the second wedge becomes wedged. The first wedge can then be applied to the threaded rod and pushed between the panel elements until a positive connection is achieved.

In this embodiment variant, the clamping wedge preferably comprises a nut, the nut being screwed onto the threaded rod via the first wedge which can be displaced along the threaded rod. By tightening the nut on the threaded rod, the wedges between the panel elements are moved towards each other. The panel elements arranged in a recess of a wooden element can therefore be pressed ever more strongly against the wooden elements by tightening the nut. That is, tightening the nut also causes the projections on the first surface to be pressed in. In addition, a tension spring or tension washer can be pushed onto the threaded rod between the nut and the first wedge. Furthermore, washers can be attached between the nut and the first wedge or between the nut, wedge and tension washer. Lock nuts or lock nuts may also be used. These allow a particularly secure connection and prevent the nuts from coming loose.

Furthermore, the at least one tensioning element can be a tension rod. The tension rod can, for example, comprise two pin-shaped threaded connecting means such as threaded rods and a nut. The two threaded rods engage with the nut, with which the length of the tension rod can be changed. By introducing at least one tension rod transversely between the panel elements, the panel elements can be pressed into the wooden element by tensioning the tension rod. Furthermore, the tension rod can also only comprise a pin-shaped connecting means such as a threaded rod, onto which a nut including tension spring and sleeve can be applied. The sleeve rests on the second surface of the first panel element and the pin-shaped connecting means rests on the second surface of the second panel element (or vice versa). By turning the nut, the tension rod can in turn be clamped between the panel elements and enables the projections to be pressed and snapped into the wooden element, advantageously the pointed projections.

In a further embodiment variant, the second surfaces of the first and second panel elements each comprise at least one tensioning element recess opposite each other, wherein the at least one tensioning element can be clamped in the at least one tensioning element recess between the first and second panel elements.

The tensioning element recess can be designed in the form of inclined surfaces on the second surfaces of the panel elements, against which the tensioning elements can rest. If the tensioning elements comprise wedges, the sloping side surfaces of the wedges can rest on these sloping surfaces and run along the sloping surfaces when the clamping wedge is tightened. In the case of two wedges, the panel elements comprise at least two oppositely inclined tensioning element recesses in the form of inclined surfaces, against which the oppositely directed wedges can rest.

In addition, the tensioning element recess can comprise a circular recess in which the tension rods can lie in. This prevents the tension rods from slipping sideways.

In summary, the tensioning elements, on the one hand, form a positive connection with the panel elements. On the other hand, the tensioning element prevents the projections on the first surfaces, which can be, for example, spikes, prongs, teeth, grooves, notches, grooves or the like, from migrating out of the wooden elements, since the panel elements are constantly pressed/pre-stressed against the wooden elements by the tensioning element.

In a further embodiment variant, the connecting means comprises a head plate, wherein the head plate can be connected to the first and second panel elements. The head plate particularly preferably comprises at least one elongated hole to which one of the panel elements can be screwed to the head plate. This allows movement of the panel element relative to the head plate. Since the distance between the panel elements changes when the tensioning element is clamped, at least one panel element must be movable relative to the head plate. As a result, the panel elements together with the head plate can be clamped to a wooden element and the head plate can then be attached to another component.

The object set according to the invention is also achieved by a system comprising a connecting means according to the invention and two wooden elements. The wooden elements have adjacent recesses, with the first and second panel elements being fixed opposite each other in the adjacent recesses of the wooden elements, wherein the projections 4 are pressed into the wooden element on the first surface, the at least one tensioning element 3 being positively clamped between the panel elements, the wooden elements being positively and non-positively connected to the connecting means.

In addition, the invention can also relate to a system comprising a connecting means according to the invention with a head plate, a wooden element having a recess and a component. In this system, the first and second panel elements are fixed opposite each other in the recess of the wooden element, the first surfaces of the panel elements resting on the wooden element, the projections on the first surface being pressed into the wooden element, wherein the head plate is fixed to the component, the wooden element being positively and non-positively connected to the component using the connecting means.

Furthermore, the object set according to the invention is achieved by a method for connecting at least two wooden elements with a connecting means according to the invention, the wooden elements being arranged next to one another and having at least one continuous recess. The method includes the following steps:
inserting the connecting means together with panel elements and tensioning elements into the at least one recess of the wooden elements, the first surface of the first and second panel elements each pointing in the direction of the wooden elements,
tensioning the tensioning element until the panel elements are positively and non-positively connected to the wooden elements.

The connecting means according to the invention is preferably introduced into the recess of the wooden elements as a package, that is to say with panel elements and the at least one tensioning element. For this purpose, the panel elements can be secured in the assembly position with the tensioning element arranged between them with a band or a wire. While the connecting element is being pressed in, i.e. while the tensioning element is being tensioned, the band or wire can break. This enables very easy transport of the connecting means, which consists of at least three parts.

In addition, the invention also includes a method for connecting a wooden element having a recess to a further component with a connecting means which has a head plate attached. The method essentially corresponds to the method for connecting at least two wooden elements, with the head plate being fixed to the component in a final step.

The projections on the first surfaces of the panel elements can be pressed ever deeper into the wooden elements while the tensioning element is being tightened and finally snap into place. Particularly preferably, after the projections have snapped into place, the tensioning element is pre-stressed in such a way that the panel elements are permanently overpressed. This prevents the projections from migrating out, even in the event of subsequent changes to the geometries, which occur, for example, due to swelling or shrinking of the wooden elements. The tensioning elements can be pre-tensioned using a torque wrench.

When using a clamping wedge as a tensioning element with a first and second wedge, a threaded rod and a nut, in the method according to the invention, the clamping wedge is first pushed between the surface elements with the second wedge screwed onto one end of the threaded rod. The first wedge or nut can then be plugged or screwed onto the other, free end of the threaded rod and the nut can be tightened until the panel elements are connected to the wooden elements in a positive and non-positive manner.

### DETAILED DESCRIPTION OF THE INVENTION

In order to better illustrate the invention, the essential features are shown in the following figures using preferred embodiments of the connecting means according to the invention for connecting wooden elements.

### DESCRIPTION OF THE FIGURES

FIGS. 1A and 1B show the use of the connecting means according to the invention for connecting a wooden element to a steel beam (FIG. 1A left), for connecting second wooden elements (FIG. 1A right) and for connecting a wooden element to mineral components with reinforcement (FIG. 1B).

FIGS. 2A and 2B show the use of the connecting means according to the invention for connecting a wooden element to a wide flange beam (FIG. 2A left), for connecting second wooden elements (FIG. 2A right) and for connecting a wooden element to mineral components with reinforcement (FIG. 2B) with a structurally effective intermediate layer that serves, for example, as thermal insulation or an airtight layer between the connected components.

FIG. 3A shows the connecting means according to the invention with two flat panel elements and a clamping wedge with two continuous wedges.

FIG. 3B shows the connecting means according to the invention with two flat panel elements and several clamping wedges, each with two wedges.

FIG. 4 shows the connecting means according to the invention with two panel elements and several clamping wedges, each with two trapezoidal wedges and exemplary positive tensioning element recesses in the form of inclined surfaces on the panel elements.

FIG. 5A shows the connecting means according to the invention with two panel elements and several clamping wedges, each with two trapezoidal, mutually facing wedges and tensioning element recesses in the form of continuous inclined surfaces on the panel element.

FIG. 5B shows the connecting means according to the invention with two panel elements and several clamping wedges, each with two trapezoidal wedges pointing away from one another and tensioning element recesses in the form of continuous inclined surfaces on the panel element.

FIG. 6A shows the connecting means according to the invention with two flat panel elements and several tension rods, each with two pin-shaped connecting means and a nut.

FIG. 6B shows the connecting means according to the invention with two flat panel elements and several tension rods, each with a pin-shaped connecting means, a nut, a tension spring and a sleeve.

FIG. 7A shows an embodiment of the connecting means according to the invention with two convexly curved panel elements and a clamping wedge with cylindrical wedges adapted to the curvature of the panel elements.

FIG. 7B shows an embodiment of the connecting means according to the invention with two convexly curved panel elements and a clamping wedge with conical wedges adapted to the curvature of the panel elements.

FIG. 8A shows a schematic representation of three different embodiment variants of the projections on the first surfaces of the panel elements.

FIG. 8B shows a detailed view of the panel elements with tooth-shaped (FIG. 8B left) and granular-shaped (FIG. 8B right) projections.

FIG. 9A shows a perspective view of a connecting means according to the invention including the head plate.

FIG. 9B shows a perspective view of a connecting means according to the invention including the head plate and the component attached to it.

FIGS. 10A and 10B show a cross section through a wooden element with connecting means according to the invention inserted into the recess on the bottom (FIG. 10A) and on the top (FIG. 10B).

FIG. 11A shows a cross section through two (FIG. 11A left) or one (FIG. 11A right) wooden element with pressed-in, pin-shaped connecting means with convexly curved panel elements.

FIG. 11B shows a perspective view of the pin-shaped connecting means with convexly curved panel elements with two wooden elements and two head plates.

FIG. 12 shows the connecting means according to the invention, each with two first and second panel elements and several clamping wedges, wherein both, first and second panel elements being connected by means of a filler plate and a plate.

FIG. 13 shows the connecting means with two first and second panel elements and with a continuous clamping wedge in the form of a toothed rail.

FIG. 14 shows the connecting means according to the invention, each with two first and second panel elements and several clamping wedges, wherein both, first and second panel elements being connected by means of end screws.

FIG. 15 shows the connecting means according to the invention, each with two first and second panel elements and several clamping wedges, the clamping wedges being cast between the panel elements.

### DETAILED DESCRIPTION OF THE INVENTION

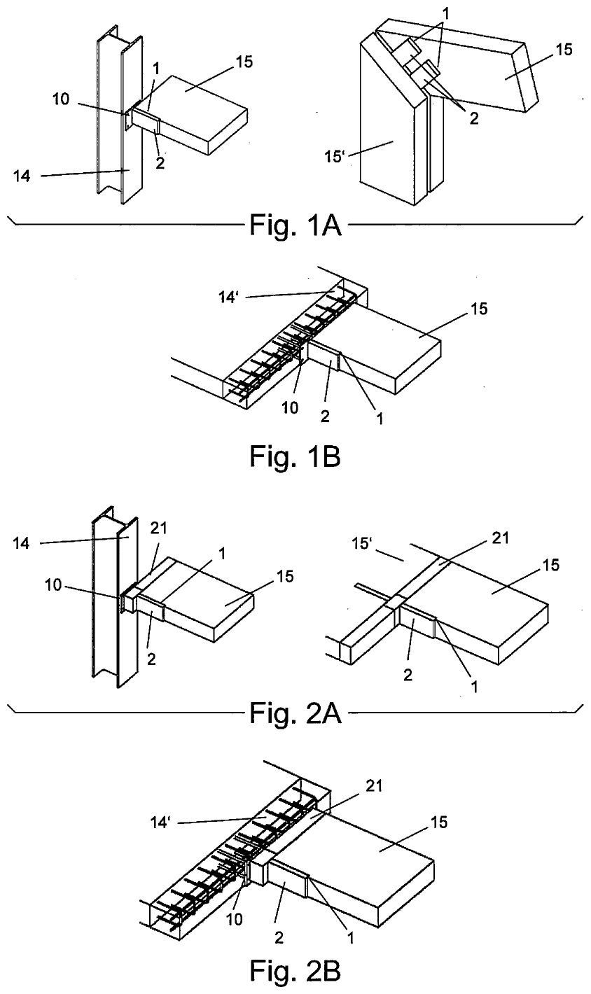

As can be seen in FIGS. 1A, 1B, 2A and 2B, the connecting means according to the invention enables the connection of wooden elements 15 to a wide variety of components 14 and can be adapted to different conditions. In these figures only a section of the wooden element 15 is shown in order to better represent the connecting means according to the invention. In particular, the recess 16 on the wooden elements 15, 15′ is not visible in FIGS. 1-2.

With the help of the connecting means, which comprises two panel elements 1, 2 and a tensioning element 3, two wooden elements 15, 15′ can, for example, be connected in a very simple manner (see FIG. 1A on the right). The resulting coupling has a high load capacity and rigidity.

In addition, the connecting means according to the invention also allows wooden elements 15 to be fastened to mineral components with reinforcement 14′ such as reinforced concrete (FIG. 1B) or to components such as steel beams 14 (FIG. 1A left). To connect the connecting means to the component 14, 14′, the connecting means according to the invention in these embodiment variants also includes a head plate 10. The component 14, 14′ can be fixed to this head plate 10. Furthermore, a structurally effective intermediate layer 21, which serves, for example, as thermal insulation or airtight layer, can also be attached between the wooden element 15 and the component 14, 14′, as shown in FIGS. 2A and 2B. For example, the intermediate layer 21 can also be an elastomer for acoustic decoupling. A connection through this intermediate layer 21 can be made using pin-shaped connecting means, which can be run through the intermediate layer 21.

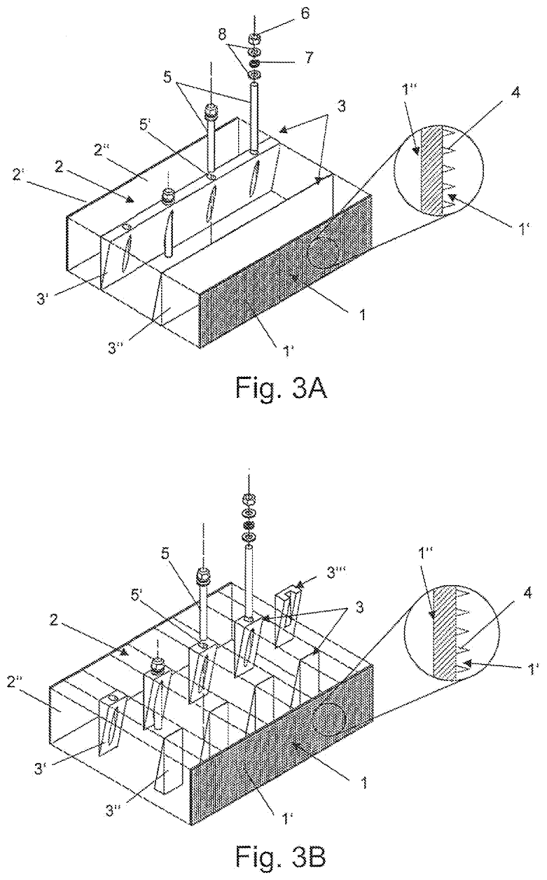

In the FIGS. 3-7, the connecting means according to the invention is shown in different embodiment variants. The essential components of the connecting means are the first and second panel elements 1, 2 and the tensioning element 3. The panel elements 1, 2 each have a first and second surface 1′, 2′, 1″, 2″. The first surfaces 1′, 2′ of the panel elements 1, 2 include projections 4. In the FIGS. 3-7, the connecting means are shown, among other things, in exploded drawings in order to better illustrate the structure of the connecting means according to the invention. The projections have a tip.

In the embodiment variant shown in FIG. 3A, the connecting means comprises two panel elements 1, 2 and a tensioning element 3, which comprises a first and a second wedge 3′, 3″ and a pin-shaped connecting means 5. The wedges 3′, 3″ each extend over the entire length of the panel elements 1, 2 and have a tapering wedge shape. The first and second wedges 3′, 3″ are arranged opposite each other between the panel elements 1, 2, with the first wedge 3′ being rotated by 180° relative to the second wedge 3″. In other words, the two tapered ends of the first and second wedges 3′, 3″ point towards each other. The pin-shaped connecting means can be a threaded rod. The second wedge 3″ can include a threaded hole 5″. Using the internal thread of this hole 5″, the second wedge 3″ can be screwed onto the threaded rod 5 and then engages with it. This means that the basic shape of the bore 5″ essentially corresponds to the basic shape of the threaded rod 5. The first wedge 3′ preferably also has a bore 5′, which, however, cannot include an internal thread. The basic shape of the hole 5′, 5″ can be identical. The first wedge 3′ with a 5′ hole without an internal thread can therefore simply be pushed onto the threaded rod 5. Above this first wedge 3′, a nut 6 can be screwed onto the threaded rod 5 for fixation. In addition, washers 8 and/or a tension washer, plate spring, spring washers 7 or a tension spring element may be attached between the nut 6 and the first wedge 3′.

The connecting means can be used to fasten a wooden element 15 to another component 14 by placing the panel elements 1, 2 opposite each other in a recess in the wooden element 16. The first surfaces of the panel elements 1, 2, which have the projections 4, rest on the wooden element 15 and allow a frictional and positive connection of the panel elements 1, 2 with the wooden element 15. With the help of the tensioning element 3, a rigid connection can be realized by clamping the tensioning element 3 between the panel elements 1, 2 on the second surfaces 1″, 2″. According to the embodiment variant in FIG. 3A, before the panel elements 1, 2 are introduced into the recess of the wooden element 16, the second wedge 3″ is preferably brought into engagement with the pin-shaped connecting means 5 and pushed together with the pin-shaped connecting means 5 between the panel elements 1, 2. The first wedge 3′ can then be pushed onto the free end of the pin-shaped connecting means 5. The nut 6 and possibly washers 8 and tension washers 7 can then be brought into engagement with the pin-shaped connecting means 5 above the first wedge 3′. After that, the connecting means according to the invention can be inserted into the recess of a wooden element 16. In the embodiment variant shown in FIG. 3A, the nut 6 is then tightened until the tensioning element 3 is positively clamped between the surface elements 1, 2. As a result, the projections 4 on the panel elements 1, 2 are pressed deeper into the wooden element 15. As a result of the pressing process of the tensioning elements 3, the distance between the panel elements 1, 2 also changes. Since the tensioning element 3 remains between the panel elements 1, 2, the projections 4 are prevented from migrating out of the wooden element 15.

However, the wedges 3′, 3″ may also be pressed between the panel elements 1, 2 using a fitting bolt or a threaded spindle.

The connecting means shown in FIGS. 3B-6B differ in their embodiments from the connecting means shown in FIG. 3A by the shape of the wedges 3′, 3″, 3′″. The surface elements 1, 2 in the embodiment variants in FIGS. 3-6 are plates, which preferably have a thickness of 3 to 40 mm.

In the embodiment variant in FIG. 3B, the tensioning element 3 of the connecting means does not comprise two wedges extending over the entire length of the panel elements 1, 2, but rather several clamping wedges, each with a first and second wedge 3′, 3″. The wedges 3′, 3″ in turn have the typical tapering wedge shape and each clamping wedge also includes a pin-shaped connection. For this purpose, the first wedge 3′ and the second wedge 3″ each have a hole 5′, 5″, whereby the holes 5′, 5″ can comprise an internal thread. In addition, the clamping wedges can also include a nut 6, which can also be brought into engagement with the pin-shaped connecting means 5, preferably above the first wedge 3′. In addition, at least one washer 8 can be attached between the nut 6 and the first wedge 3′. A tension washer 7 can also be attached between the nut 6 and the first wedge 5′. Washers 8 can be applied in between. The tension washer 7 allows the high preload to be maintained in the screw connection. Due to spring forces, the nut 6 is prevented from being loosened by the pin-shaped connecting means 5.

In a preferred embodiment variant in FIG. 3B, the wedge 3′″ has a groove instead of the bore 5′ which receives the pin-shaped connecting means 5 with which the wedge 3′″ is brought into engagement. The groove can have any section that is suitable for receiving the pin-shaped connecting means 5.

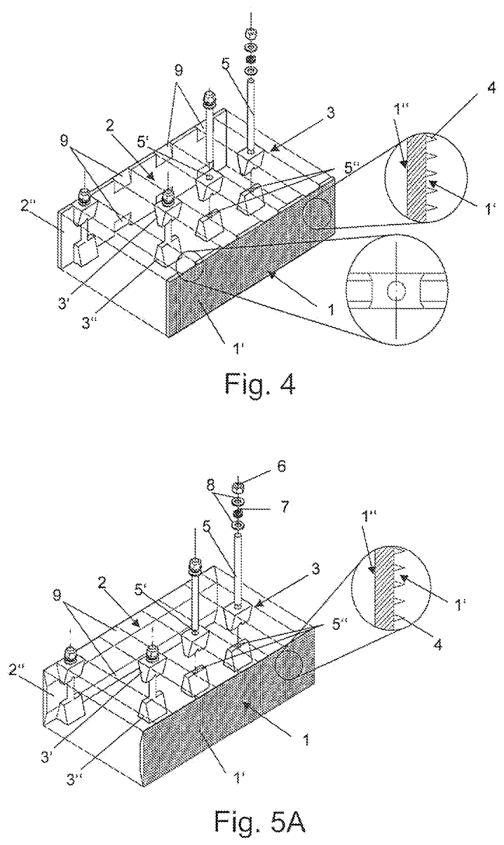

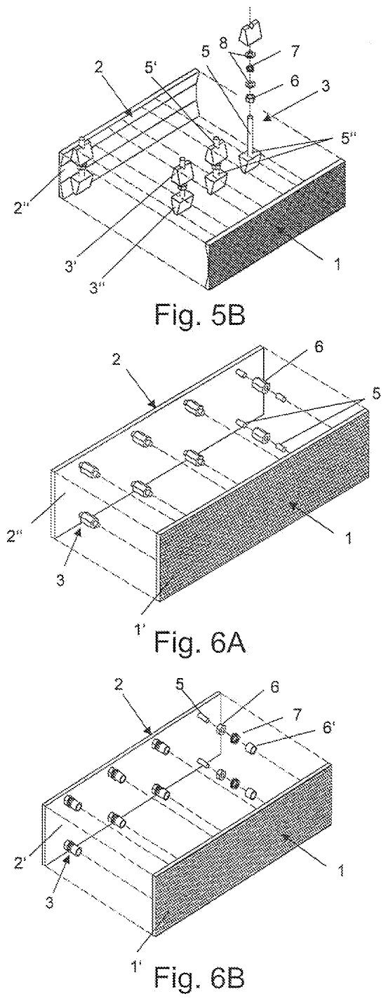

The tensioning elements 3 shown in FIGS. 4, 5A and 5B differ from the tensioning elements 3 shown in FIG. 3B by the shape of the first and second wedges 3′, 3″, 3′″. Due to the shape of the wedges 3′, 3″, 3′″, the second surfaces of the panel elements 1″, 2″ facing the clamping wedges also have tensioning element recesses 9. The tension element recesses 9 create inclined surfaces on the second surfaces of the panel elements 1″, 2″, against which the wedges 3′, 3″, 3′″ can rest. These inclined surfaces are each designed at opposite locations on the second surfaces of the panel elements 1″, 2″. FIG. 4 has a plurality of tensioning element recesses 9, with oppositely inclined surfaces on the second surfaces of the panel elements 1, 2 on the top and bottom of the panel elements 1, 2, 5a and 5b each have continuous recesses 9 on the top and bottom of the panel elements 1, 2, which in turn are inclined in opposite directions. Therefore, in these embodiment variants, the clamping wedges can be attached at any point along the panel elements 1, 2. The wedges 3′, 3″ in the embodiment variants in FIGS. 4, 5A and 5B are trapezoidal. The wedges 3′, 3″, 3′″ in turn have bores 5′, 5″ or grooves in order to be brought into engagement with the pin-shaped connecting means 5. The attachment of the wedges 3′, 3″, 3′″ therefore works analogously to the embodiment variants shown in FIGS. 3A and 3B.

In the embodiment variant in FIG. 5B, the clamping wedges have the same wedges 3′, 3″ as in FIGS. 4 and 5A. However, the tapered ends of the wedges 3′, 3″ point away from each other in this embodiment variant, while they point towards each other in FIGS. 4 and 5A. An advantage of the embodiment variant shown in FIG. 5B is that the tensioning element recesses 9 are made in the middle of the panel elements 1, 2. Therefore, in this case, more material is available on the edge zones of the connecting means, that is, on the top and bottom sides of the surface elements 1, 2. Since higher tensions usually occur at the edge zones, a safer and more stable connection can be guaranteed.

The tensioning element recesses 9 in FIG. 5B again extend over the entire length of the panel elements 1, 2, to which the clamping wedges can therefore be clamped at any point.

FIGS. 6A and 6B show a further embodiment of the connecting means according to the invention with a tensioning element 3, which comprises a tension rod. This tension rod is clamped transversely between the panel elements 1, 2 and allows the projections 4 on the first surfaces of the panel elements 1′, 2′ to be pressed into a wooden element 15. As shown in FIG. 6A, the tension rods can, for example, comprise a nut 6, preferably a long nut, and two pin-shaped connecting means 5, which engage with the nut 6. The length of the tension rod can be changed by turning the nut 6.

This means that turning the nut 6 enables the panel elements 1, 2 to be pressed into a wooden element. In addition, as shown in FIG. 6B, the tension rods can also only comprise a pin-shaped connecting means 5, which can engage with a nut 6, a tension spring 7 and a sleeve 6′. The length of the tension rod can in turn be changed by turning the nut 6.

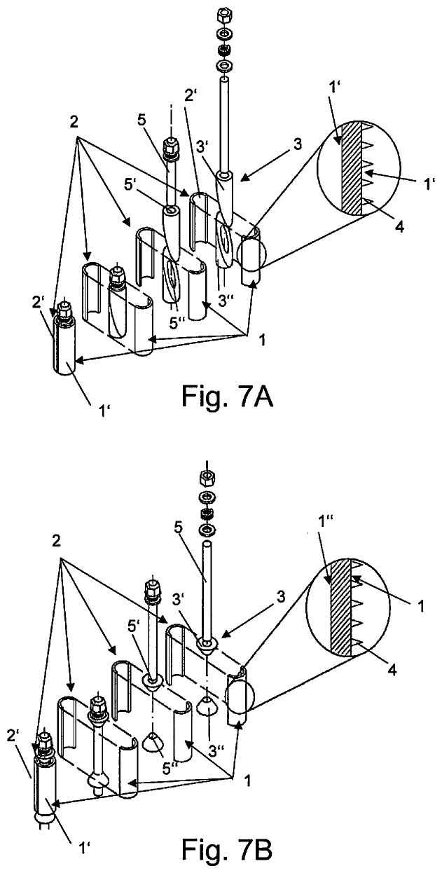

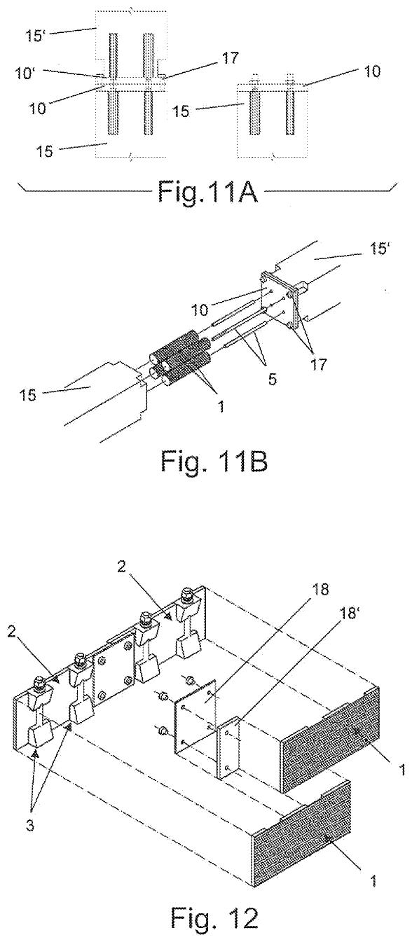

A further embodiment variant of the connecting means according to the invention is shown in FIGS. 7A and 7B. The connecting means is shown in four different views to illustrate the structure. In this embodiment variant, the surface elements 1, 2 are convexly curved and have projections 4 on the first surfaces 1′, 2′. These first surfaces 1′, 2′ can face a wooden element 15, so that the projections 4 can be pressed into the wooden element. The tensioning elements 3 of the connecting means in FIGS. 7A and 7B can, on the one hand, comprise cylindrical wedges 3′, 3″ (FIG. 7A) or conical wedges 3′, 3″ (FIG. 7B). The curvature and/or the radius of the wedges 3′, 3″ essentially correspond to the curvature and/or the radius of the curved panel elements 1, 2. FIGS. 11A and 11B show application examples of this embodiment variant of these pin-shaped connecting means with projections, which can, for example, replace a glued-in bolt. On the left side in FIG. 11A and in FIG. 11B, two wooden elements 15, 15′ are connected using the connecting means according to the invention and two head plates 10, 10′. The connecting means are fixed to the head plates 10, 10′ using nuts 6. The head plates 10, 10′ may then be screwed together with screws 17. On the right side in FIG. 11A, only a wooden element 5 with fixed connecting means and a head plate 10 is shown.

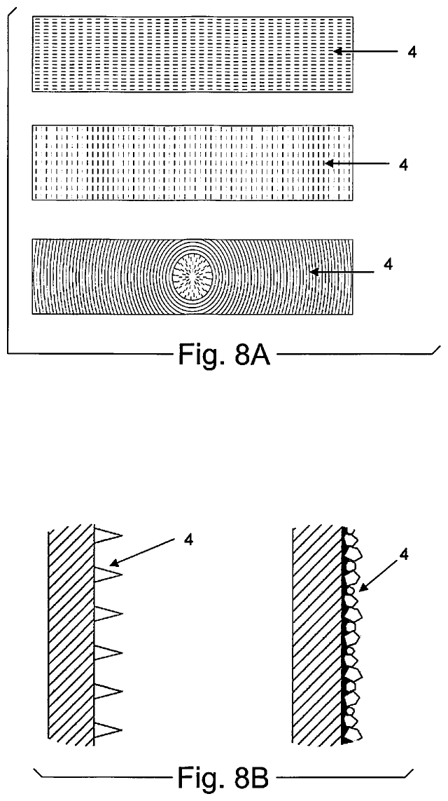

As shown in FIGS. 8A and 8B, the density and type of the projections 4 on the first surfaces of the panel elements 1′, 2′ can vary. In FIG. 8A, three different arrangement options for the projections 4 are shown as examples: transverse (FIG. 8A, top), longitudinal (FIG. 8A, middle) and radial (FIG. 8A, bottom). In FIG. 8B, tooth-shaped projections 4 are shown on the left side and granular projections 4 on the right side. The granules can be glued to the first surfaces of the panel elements 1′, 2′. Other projections 4 such as teeth, prongs, hooks or serrations can be punched out directly from the panel element 1, 2 or produced using a special surface treatment.

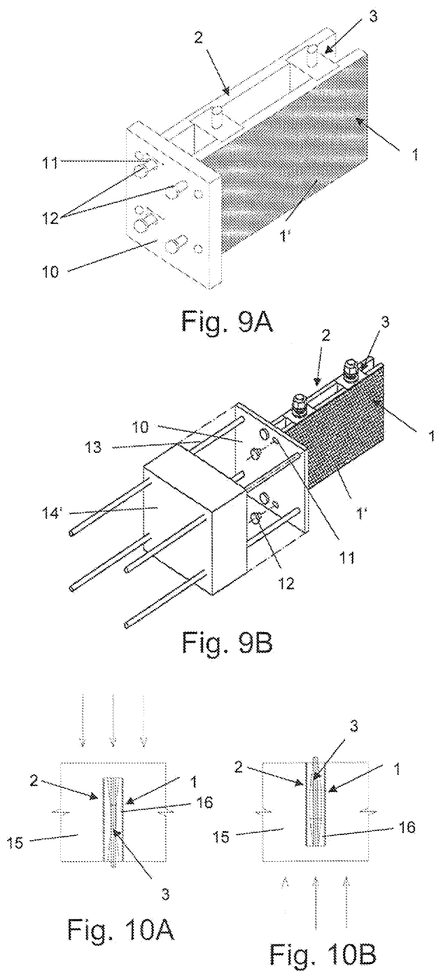

FIGS. 9A and 9B show a possibility of connecting the panel elements 1, 2 with a head plate 10. The panel elements 1, 2, which are plates in the embodiment variant in FIGS. 9A and 9B, can be connected to the head plate using a pin-shaped connecting means 12, for example a bolt or a screw. For this purpose, the head bar 10 has at least two recesses. At least one recess has the shape of an elongated hole 11, so that the pin-shaped connecting means 12 can be moved along the elongated hole 11. This means that the distance between the panel elements 1, 2 can still be varied despite the head plate 10 being connected. This means that the connecting means according to the invention, together with the head plate 10, can be attached to a wooden element 15 by inserting the panel elements 1, 2 into the recess of the wooden element 15 and then using the tensioning element 3 to connect them to the wooden element 15 in a positive and frictional manner. The head plate 10 can be fixed to another component 14, 14′, such as a steel beam 14 or a mineral component with reinforcement 14′, using pin-shaped connecting means 13.

The recess in the wooden element 16, into which the surface elements 1, 2 can be introduced, may be a continuous gap. As shown in FIGS. 10A and 10B, the recess on the wooden element 16 can also be, for example, a slot on the top (FIG. 10B) or bottom (FIG. 10A) of the wooden element 15. Because the wooden element 15 only includes recesses 16 on the bottom (FIG. 10A), penetration of moisture or humidity from the top is prevented. In this embodiment variant, the top of the wooden element 15 has no recesses, so that the tightness is not reduced. Such an attachment of the connecting means according to the invention is therefore particularly suitable for wooden elements 15 which are exposed to water or rain, such as the wooden elements of a roof structure.

In contrast, the connecting means can also be attached to slots on the top of the wooden element 15. This embodiment variant offers good fire protection since the bottom of the wooden structural elements 15 do not include any recesses. Therefore, such a construction method would be suitable, for example, for wooden elements 15 in interior spaces.

FIGS. 12-15 show further embodiment variants of the connecting means according to the invention, which also make it possible to compensate for construction tolerances. More precisely, the connecting means offer a possibility of bridging tolerances in the joint area of the wooden elements/construction components. In these embodiment variants, the connecting means comprises two first and two second panel elements 1, 2. When connecting two wooden elements 15, 15′, a first and panel element 1, 2 can be attached to one of the wooden elements 15, 15′. Due to construction tolerances, the recesses 16 cannot overlap exactly at the panel joint of the wooden elements 15, 15′ (FIGS. 12, 14 and 15). Due to this lateral offset of the recesses 16, it is not possible to press in only one panel element 1, 2 along the recesses 16 of the wooden elements. The two first and second panel elements 1, 2 cannot then be attached in one plane, as shown in FIGS. 12, 14 and 15. In order to compensate for this offset, filler plates 18′ can be attached as shown in FIG. 12, which compensate for the offset. The two first and second surface elements 1, 2 are connected with another plate 18.

In addition, the offset according to FIG. 14 can be compensated for by fixing an end screw connection with elongated holes 19, 19′ on one of the first and one of the second panel elements 1, 2. The elongated holes allow adjustment to the size of the offset.

In a further embodiment variant, the openings in the recesses can be subsequently filled using reaction resins, as shown in FIG. 15. This in turn allows the construction tolerances to be compensated.

The openings in the recesses of the wooden structures and components 15, 14 can of course also be cast in all other design variants. The reaction resins can be, for example, polymer concrete, epoxy resin or even mortar or concrete. Pouring prevents moisture from penetrating or the formation of condensation. This casting creates composites that can participate in the transfer of loads between the components.

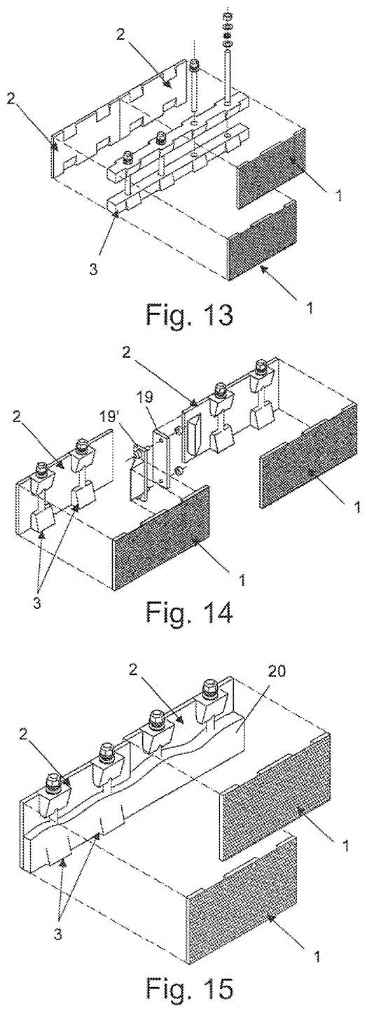

Another possibility of optimizing the transmission of forces using the connecting means according to the invention is shown in FIG. 13. On the one hand, the continuous tensioning element 3, which has the shape of a toothed rail, allows the two first and second panel elements 1, 2 to be connected without additional connecting means. On the other hand, the second surfaces of the panel elements 1″, 2″, i.e. the surfaces on which the tensioning element 3 rests, can also have projections such as teeth in this embodiment variant. Therefore, the tensioning element 3 can also serve to transmit forces.

1. A connecting means for connecting a wooden element having a recess to a further component, comprising
at least a first panel element and at least a second panel element and,
at least one tensioning element,
wherein the at least one first and second panel element lie opposite of each other, having a distance when inserting the connecting means together with the first and second panel elements and tensioning elements into the recess of the wooden elements, wherein the distance being variable when tensioning the tensioning element, wherein the at least one first and second panel elements each having a first and second surface, the second surfaces of the first and second panel elements facing each other, the first surfaces of the first and second panel elements having projections, wherein the at least one tensioning element can be positively clamped between the at least one first and second panel element.

2. The connecting means according to claim 1, wherein the projections are distributed over the entire first surfaces of the panel elements, a shape of the projections being selected from the group consisting of serrations, tines, teeth, grooves, notches, grooves, hooks or granules.

3. The connecting means according to claim 1, wherein the projections are pointed.

4. The connecting means according to claim 1, wherein the panel elements consist of steel, stainless steel, aluminium or plastics.

5. The connecting means according to claim 1, wherein the panel elements are plates, wherein the plates having a thickness of 3 to 40 mm.

6. The connecting means according to claim 1, wherein the first and second panel elements are convexly curved, the first and second panel elements forming a pin-shaped connecting element with the tensioning element arranged between them.

7. The connecting means according to claim 1, wherein the at least one tensioning element is a clamping wedge.

8. The connecting means according to claim 1, wherein the at least one tensioning element is a tension rod.

9. The connecting means according to claim 7, wherein the at least one clamping wedge comprises a pin-shaped connecting element selected from a fitting bolt, a threaded rod or a spindle, and at least one wedge, wherein the at least one wedge has a bore or a groove with which the pin-shaped connecting element engages.

10. The connecting means according to claim 9, wherein the at least one clamping wedge comprise comprises a first and second wedge having the same tapered basic shape and engaging with the pin-shaped connecting element in such a way that tapered ends of the wedges point towards or away from one another, wherein the wedges rest with at least one wedge surface on the second surface of the first or second panel element.

11. The connecting means according to claim 10, wherein the second surface of the first and second panel elements each comprises at least one tensioning element recess opposite each other, wherein the at least one tensioning element is clamped in the at least one tensioning element recess between the first and second panel elements.

12. The connecting means according to claim 1, wherein a head plate is connectible to the first and second panel elements.

13. The connecting means according to claim 1, wherein a distance between the first and second panel elements is 4 mm to 80 mm.

14. A system comprising a connecting means according to claim 1 and two wooden elements, wherein the wooden elements have adjacent recesses,
wherein the at least one first and second panel element are fixed opposite each other in the adjacent recesses, wherein the first surfaces of the first and second panel elements rest on the wooden elements and the projections on the first surface of the first and second panel element are pressed into the wooden structural elements so they are removeably connected to the connecting means.

15. The system comprising a connecting means according to claim 14, one of the wooden-element elements having a recess and a further component, wherein the first and second panel elements are fixed opposite each other in the recess of the wooden element, the first surfaces of the first and second panel elements resting on the wooden element, wherein the projections on the first surface are pressed into the wooden element, wherein a head plate is fixed to the component, the wooden element being removeably connected to the component by the connecting means.

16. A method for connecting at least two wooden elements with a connecting means according to claim 1, wherein the wooden elements are arranged next to each other, having a continuous recess, by the steps of
inserting the connecting means together with the first and second panel elements and tensioning elements into a recess of the wooden elements, wherein the first surface of the panel elements each point in the direction of the wooden elements,
tensioning the tensioning element until the panel elements are removeably connected to the wooden elements,
wherein the projections are pressed deeper into the wooden component during the tensioning of the at least one tensioning element and finally snapping into place, wherein the at least one tensioning element is pre-stressed after snapping in such a way that the first and second panel elements are permanently overpressed.

17. The method for connecting a wooden component having a recess to a further component with a connecting means according to claim 14 with a head plate attached to the first and second panel elements, by the following steps
inserting the connecting means together with the first and second panel elements and tensioning elements into the recess of the wooden elements, wherein the first surface of the first and second panel elements each point in the direction of the wooden elements,
tensioning the tensioning element until the first and second panel elements are removeably connected to the wooden elements, and
screwing the head plate onto the component.
